(19) United States
(12) Patent Application Publication
(10) Pub. No.: US 2017/0165627 A1
(43) Pub. Date: Jun. 15, 2017

(54) MICROENCAPSULATION PROCESS

(71) Applicant: ENCAPSYS, LLC, Appleton, WI (US)

(72) Inventors: Biao Duan, Appleton, WI (US); Nianxi Yan, Appleton, WI (US)

(73) Assignee: ENCAPSYS, LLC, Appleton, WI (US)

(21) Appl. No.: 15/372,545

(22) Filed: Dec. 8, 2016

Related U.S. Application Data
(60) Provisional application No. 62/265,302, filed on Dec. 9, 2015.

(51) Int. Cl. B01J 13/18

(52) U.S. Cl. CPC B01J 13/18

(57) ABSTRACT

A microencapsulation process in which wall forming materials in a dispersed phase are polymerized to form a seed microcapsule after which an initiator or catalyst in the continuous phase is initiated or activated to effect, in whole or in part, full polymerization of the wall forming material of the dispersed phase.

The present application claims the benefit of prior filed U.S. Provisional Application No. 62/265,302 filed Dec. 9, 2015 entitled “Microencapsulation Process”, the contents of which are hereby incorporated herein in their entirety by reference.

The present disclosure is directed to a multi-step microencapsulation process in which a seed microcapsule is formed from polymerizable wall forming materials in the dispersed phase after which full microcapsule wall formation is effected through continued polymerization of the wall forming material whose polymerization is initiated or catalyzed, in whole or in part, by a continuous phase initiator or catalyst.

### BACKGROUND

Microcapsules and microencapsulation technology are old and well known and their commercial applications varied. Microcapsules have played a significant role in various print technologies where a paper or other like substrate is coated with microcapsules containing ink or an ink-forming or inducing ingredient which microcapsules release the ingredient, generating an image, when fractured by pressure, as by a printing press or a stylus. Microcapsules have also played a significant role in various adhesive and sealant technologies. Early embodiments involved the encapsulation of solvents for solvent swellable/tackified preapplied adhesives whereby fracture of the microcapsules releases the solvent which softens or tackifies the adhesive to enable bonding and which adhesives re-hardened upon evaporation of the solvent. In other adhesive and sealant applications, the microcapsules contain one or more components of a curable or polymerizable adhesive or sealant composition which, upon release, leads to the cure or polymerization of the adhesive or sealant. In all of these early applications, functionality and efficacy, especially for long term storage and utility, is dependent upon the integrity of the microcapsule walls where the sought after integrity pertains to both strength, so as to avoid premature fracture, as well as impermeability, so as to prevent leakage and/or passage of the contents of the microcapsule through the microcapsule walls. In the former situation, parts having a preapplied microencapsulated adhesive have a tendency to bond together if they hit one another or are stacked upon one another where the pressure of the stack is sufficiently high. Even if not bonded, the fracture of the microcapsules results in less adhesive to effect the bond when the bond is intended. Similarly, if the microcapsule walls allow permeation of the active components through the cell wall, even a slow permeation, the product is short lived as cure will be effected when not intended.

As with most any technology, evolution of microencapsulation technology has led to many new applications, including applications that require changes in the physical properties of the microcapsules, especially their walls. New applications require microcapsules that fracture more readily, with less pressure, but not prematurely. Other applications require microcapsules that specifically allow for a controlled, slow release or permeation of the contents from within the microcapsules without the need to actually fracture the same. For example, perfume containing microcapsules are oftentimes applied to advertising inserts in magazines so that the reader can sample the smell of the perfume. Here strength is needed to avoid premature fracturing of the microcapsules due to the weight and handling of the magazine; yet, the microcapsules need ease of fracture so that the reader can simply scratch the treated area to release the contents of the microcapsule. At the same time, it is desirable to allow for some release of the contents, even without fracturing, to induce the reader to want to scratch the sample to get a more accurate sense of the smell.

Another application for microcapsules is in laundering and fabric treatments. A number of products exist wherein microcapsules of various ingredients, including perfumes, are applied to strips of a fabric material and added to the dryer wherein the tumbling action and/or heat of the dryer causes the microcapsules to fracture, releasing the ingredients which, in a volatilized state, permeate and deposit upon the contents of the dryer. This methodology applies that “fresh out of the dryer” smell, but is short lived as the perfume continues to volatilize from the treated fabric. Other products exist whereby microcapsules containing perfumes and other ingredients are applied directly or indirectly to the fabric, especially apparel, to provide a longer lived freshness to the same. Here, the performance or efficacy of these products is oftentimes short lived as the content of the microcapsules escapes too readily from the microcapsules and/or the walls of the microcapsules are too weak and/or have too little give such that normal wearing of the fabric causes the microcapsules to break too readily. Opportunities abound for new microcapsules that address the specific requirements of a given application as well as microcapsules that offer better performance and properties than are attainable with current state of the art microcapsule technology.

Whether end-use applications have driven the evolution of microcapsule technology or the evolution of microcapsule technology has driven their expanded applications, or perhaps a little of both, there has been and continues to be constant development in microencapsulation technology, both in terms of their production/process methodology and their chemistry. Early melamine formaldehyde microcapsules continue to evolve; yet concurrently, they have, to some extent, given way to acrylic and other microcapsule chemistries, especially free radically polymerizable chemistries, and technologies. As the chemistries have evolved so have the processes. Both have continued to evolve further, microcapsule wall are far more complex and include dual walled microcapsules of each chemistry as well as of both chemistries. While the basic building blocks of the capsule walls have largely remained the same, the specific selection of building blocks and methodology has led to newer and improved microcapsules enabling the microencapsulation of a broader array of ingredients, compounds and elements.

While early microcapsules were formed from wall forming materials in the dispersed phase or continuous phase, advancements led to processes where cell walls formed from wall forming polymerizable monomers in both the dispersed phase and the continuous phase. Other processes involved the formation of prepolymers of the wall forming material as a first step before wall formation. Still others employed sequential or simultaneous polymerization of wall forming materials from both phases to form dual walled microcapsules, microcapsules having interpenetrating networks of polymer chains of each phase, etc. In turn, each technical advancement has led to microcapsules having some unique or desired benefit as compared to those made by other processes enabling their use in new applications and in old applications with better results.

Although such advancements have had many benefits and have altered and markedly expanded the use of microcapsules in industry, most, if not all, of these advancements come at a cost as they require more complicated and/or costly processes and materials. Thus, there is a need for a simplified and less costly process for producing microcapsules. In particular, there is a need for a more simplified and less costly process for producing microcapsules having good physical properties, especially good strength, while also providing controlled and/or minimal permeability.

### SUMMARY OF THE INVENTION

In accordance with the present teachings there is provided a two-step polymerization process for the production of microcapsules wherein in the first step a seed capsule is formed from the dispersed phase and in the second step full capsule wall formation is effected, in whole or in part, by an initiator originating in the continuous phase. Each of the first and second polymerization process steps may comprise a single process step or two or more sub-steps. Multiple sub-steps are most prevalent in the first polymerization process and involve the formation of oligomers and/or prepolymers of the wall forming monomers/oligomers before initiation of the formation of the seed capsule.

The present teaching is applicable to oil-in-water microencapsulation processes, where an oil phase or hydrophobic material is to be encapsulated, as well as water-in-oil microencapsulation processes, where a water phase or hydrophilic material is to be encapsulated. The key to the present process is that the wall forming material is exclusively, or essentially exclusively, in the core composition or the dispersed phase together with a first initiator for effecting polymerization thereof and a second initiator is added to the continuous phase following formation of the seed microcapsule or, if said second initiator is not activated by the conditions effective for initiating activation of the core phase initiator it may be added to the continuous phase prior to formation of the seed capsule, i.e., it may be present in the continuous phase at the time of dispersing the core phase in the continuous phase or it may be added to the continuous phase subsequent to creating the dispersion but prior to formation of the seed microcapsule.

The present process is applicable to any polymerizable system (i.e., monomer/oligomer/prepolymer and initiator or catalyst); though it is especially suited for free radically polymerizable systems. Similarly, as noted above, the present process is applicable to oil-in-water and water-in-oil microencapsulation processes, but is especially suited for oil-in-water microencapsulation processes.

The present process produces microcapsules having improved properties as compared to microcapsules formed from the same dispersed phase composition but without the use of a continuous phase initiator or catalyst for the wall forming material of the dispersed phase.

### DETAILED DESCRIPTION

The phrase “free of or essentially free of continuous phase monomer” means that any polymerizable monomer/oligomer/prepolymer present in the continuous phase, if any, is not polymerizable under the conditions employed in the claimed microencapsulation process or, if polymerizable, is not present in an amount as will alter the physical properties of the microcapsule wall and/or will not fully or substantially encapsulate or overcoat the seed microcapsule. In this respect, this phrase is added to prevent others from trying to avoid the present claims by adding an insignificant amount of a polymerizable monomer/oligomer/prepolymer to the continuous phase where its purpose is solely to avoid the claims.

A “seed microcapsule” means a microcapsule structure that is a full, or nearly so, ellipsoid. Most preferably it is a full ellipsoid, though the present teaching is also applicable to ellipsoids that are at least 50% complete, preferably at least 75% complete, more preferably at least 85% complete, most preferably at least 95% complete. Seed microcapsules include agglomerations of two or more fully or partially formed microcapsules where adjoining microcapsules have discrete walls and/or share a common wall. In general, the walls of the seed microcapsules are readily permeable to monomer and/or initiator, most especially free radicals. Seed microcapsules cannot, however, be harvested and isolated in any suitable quantity due to their lack of structural integrity, porosity and thin walls.

The term “prepolymer intermediate” refers to wall forming, polymerizable monomers and/or oligomers that have been prepolymerized to form higher molecular weight oligomers and/or prepolymers, with or without remaining monomer.

An “oil phase composition” refers to a composition comprised of materials that are hydrophobic and/or lipophilic, though they may also include amphiphilic materials that are soluble in or miscible with hydrophobic and/or lipophilic materials.

The “core phase composition” refers to the dispersed phase and comprises the wall forming polymerizable monomer/oligomer/prepolymer and/or prepolymer intermediate and at least one polymerization initiator for effecting polymerization of the foregoing. Typically, the core composition will further comprise one or more materials to be encapsulated, which may be the polymerizable monomer or the initiator: though in these instances, the quantity thereof is sufficient so that a suitable quantity for its intended end-use application remains following complete formation of the microcapsule wall.

The term “oil phase monomer” refers to the wall forming polymerizable monomer/oligomer/prepolymer mixture and/or prepolymer intermediate that comprises or is wholly or partially soluble or dispersible in the oil phase composition and is incorporated into the oil phase composition. The oil phase monomer is the wall forming material in the case of the oil-in-water microencapsulation process.

The term “water phase monomer” refers to that wall forming polymerizable monomer/oligomer/prepolymer mixture and/or prepolymer intermediate that is wholly or partially soluble or dispersible in the water phase composition and is contained in the water phase composition. The water phase monomer is the wall forming material in the case of the water-in-oil microencapsulation process.

Typically and preferably, the oil phase monomer and/or the water phase monomer are soluble in their respective carriers or comprise the carrier themselves. As these monomers may comprise a plurality of different monomers of each class, it is to be appreciated that monomers that are “poor to moderately hydrophilic” may be used in the case of water phase monomer compositions and monomers that are “poor to moderately hydrophobic or lipophilic” may be used in the case oil phase monomer compositions so long as they are sufficiently soluble or miscible to form a stable composition. Most preferably, they are not so poorly hydrophilic or poorly hydrophobic that they will have tendency to form a gel or discrete particles as they oligomerize/polymerizes in their respective dispersed phase composition. Rather, it is important that they tend to migrate to the water/oil phase interface as polymerization ensues. In following, it is to be understood that reference to a monomer, or another material, being soluble or dispersible in a given material or composition means that the named monomer is wholly or partially soluble or dispersible therein on its own or such solubility or dispersability may be as a result of the addition of suitable emulsifies and/or solubilizers and/or as a result of elevating the temperature of the mixture and/or adjusting the pH to enhance solubility and/or dispersability.

The term “(meth)acrylate” refers to the acrylate as well as the methacrylate: when just the acrylate is intended to be exemplified, it will be so presented, e.g., isobornyl acrylate, and when just the methacrylate is intended to be exemplified, it will be so presented, e.g., isobornyl methacrylate. Hence, isobornyl (meth)acrylate refers to both isobornyl acrylate and isobornyl methacrylate. Similarly, a di(meth)acrylate may have two acrylate groups, two methacrylate groups or one acrylate group and one methacrylate group. In following, a “difunctional” monomer refers to a (meth)acrylate monomer having two ethylenically unsaturated polymerizable groups in the given monomer.

The Process

According to the present teaching there is provided a process for producing microcapsules which process comprises:

a) forming a dispersion of a core composition in a continuous phase, said core composition comprising polymerizable wall forming materials and an initiator or catalyst for effecting the polymerization of said wall forming material,

b) initiating polymerization of the wall forming materials in the core composition so as to form a seed microcapsule

c) subjecting the dispersion to conditions that initiate a catalyst or initiator present in the continuous phase which catalyst or initiator is capable of further effecting the polymerization of the wall forming materials of the core composition, and

d) allowing polymerization to continue until microcapsules of the desired wall thickness are attained, said process further characterized in that the continuous phase is free of or substantially free of continuous phase monomer.

In another respect, the present teaching is directed to an improved process for forming microcapsules wherein the microcapsules are formed from wall forming materials in the dispersed phase wherein the improvement comprises forming a seed capsule from the wall forming materials of the dispersed phase and then further polymerizing the wall forming material of the dispersed phase through activation of an initiator or catalyst in the continuous phase, with or without concurrent activation of initiator or catalyst in the dispersed phase, wherein said continuous phase is free of or substantially free of continuous phase monomer.

The present process is applicable to oil-in-water microencapsulation processes, where an oil phase or hydrophobic material is to be encapsulated, as well as water-in-oil microencapsulation processes, where a water phase or hydrophilic material is to be encapsulated. The key to the present process is that the wall forming material is exclusively, or essentially exclusively, in the core composition or the dispersed phase together with a first initiator for effecting polymerization thereof and a second initiator is added to the continuous phase following formation of the seed microcapsule or, if said second initiator is not activated by the conditions effective for initiating activation of the core phase initiator, to the continuous phase prior to formation of the seed capsule, i.e., it may be present in the continuous phase at the time of dispersing the core phase in the continuous phase or it may be added to the continuous phase subsequent to creating the dispersion but prior to formation of the seed microcapsule. The present process is especially to be applied to oil-in-water microencapsulation, most especially free-radical polymerized oil-in-water microencapsulation.

Both oil-in-water and water-in-oil microencapsulation processes and the materials employed in each are well known. Generally, the process involves multiple steps, the first of which is the preparation of the dispersed phase composition and the continuous phase composition.

The dispersed phase composition, also referred to as the core composition, comprises the material to be encapsulated, the core material; a polymerizable wall forming material or, more typically, especially in the case of free radically polymerization materials, a combination of wall forming materials; and at least one initiator or catalyst for effecting polymerization of the wall forming materials. It is to be appreciated that the core material may be one or more of the wall forming materials and/or the initiator or catalyst therefor. In these instances, the amount of the ingredient to be encapsulated must be in excess of that needed to form the microcapsule wall. Alternatively, where, especially due to the end-use application of the microcapsule, there is a benefit or need to having a microcapsule core that is free of or essentially free of initiator or catalyst, the amount of initiator or catalyst to be employed in preparing the core composition is less than that necessary to complete microcapsule wall formation. Here, the initiator or catalyst in the continuous phase completes the microencapsulation process as discussed more fully herein.

The dispersed phase composition is prepared by combining the ingredients to form a solution or stable suspension. Should it be necessary, surfactants and other materials may be added to aid in the solubility of the ingredients, especially the initiator, into the polymerizable wall forming material. Additionally or alternatively, the mixture may be subjected to elevated temperatures, but not sufficiently elevated to prematurely initiate the initiator, to aid in solubilization. Similarly, one may prepare a number of pre-mixes of any two or more components of the dispersed phase composition before the pre-mixes are combined to form the dispersed phase composition. Furthermore, again if desired, one may initiate formation of a prepolymer from the wall forming materials of the dispersed phase prior to combining with the continuous phase.

The continuous phase composition comprises a suitable medium in which the microencapsulation process is to take place: water or an aqueous based solution in the case of an oil-in-water microencapsulation process and an oil or another organic lipophilic liquid in the case of a water-in-oil microencapsulation process. Most typically the continuous phase composition will further comprise a surfactant and/or emulsifier for aiding in the creation and stability of the dispersed phase composition. Additionally, the continuous phase composition may comprise an initiator or catalyst for the polymerizable wall forming materials of the dispersed phase composition. Here, however, it is necessary that the conditions necessary for effecting initiator or activation of the initiator or catalyst are not effected by the same conditions that effect initiation or activation of the initiator or catalyst of the dispersed phase composition and/or by the conditions of the microencapsulation process prior to the intended point of activation of the continuous phase initiator or catalyst. For example, if the initiator of one phase is a light activated initiator, especially a UV photoinitiator, and the other is a heat activated initiator, the continuous phase initiator may be added to the continuous phase prior to forming the dispersion of the dispersed phase: of course, here if the continuous phase initiator is heat activated, one must be sure that the heat caused by the photoinitiator and its activation is not sufficient to effect initiation of the heat activated initiator.

Once the dispersed phase composition and continuous phase composition are prepared, one is added to the other with the continuous phase composition being in excess relative to the dispersed phase, the latter helping to avoid inversion of the intended dispersion. Most preferably, it is desirable to carefully combine the two ingredients without mixing so as to form a two-phase composition before initiating the emulsification process. Emulsification is initiated and maintained until the desired droplet size of the dispersed phase is attained. Thereafter, if desired, one may switch out the emulsification impeller or element for a more traditional mixer impeller or element, i.e., one that mixes and/or maintains a flow in the dispersion rather than an element that emulsifies. This avoids any or any significant further reduction in the droplet size.

The dispersion is then subjected to those conditions that are necessary to effect initiation or activation of the initiator or catalyst in the dispersed phase to initiate wall formation. Alternatively, if so desired, one may first subject the dispersion to such conditions as will effect pre-polymerization of the dispersed phase wall forming material to form a prepolymer intermediate in the dispersed phase. Thereafter, the dispersion is then subjected to those conditions sufficient to effect wall formation. In this instance, the dispersed phase typically comprises two or more initiators, one that is selected to form the prepolymer intermediate and the other to effect wall formation. Of course, as noted above, it is to be appreciated that a prepolymer intermediate may be used in preparing the dispersed phase composition before creation of the dispersion. In any event, polymerization is continued until a seed capsule is formed.

Following formation of the seed capsule, the dispersion is subjected to those conditions as are necessary to effect initiation or activation of the continuous phase initiator or catalyst. If the continuous phase initiator or catalyst is not already present in the continuous phase at the time of formation of the seed capsule, it is added once the seed capsule has been formed. Here, the continuous phase initiator or catalyst is added to a quantity of the continuous phase medium or another suitable and compatible liquid carrier and then the same added to the dispersion, all while continuing to mix the dispersion. Thereafter, the dispersion is subjected to those conditions that effect initiation or activation of the continuous phase initiator or catalyst. The reaction is then allowed to continue until the desired microcapsule is fully formed.

Not intending to be bound by theory, it is nonetheless believed that the seed capsule, at least in its early stages allows for monomer and/or prepolymer intermediate to pass through the wall to the interface with the oil phase and for initiator and/or free radicals to pass through the wall into the dispersed phase allowing for wall growth to continue both within and without the seed capsule wall. As wall formation continues that permeability reduces whereby only radicals are able to penetrate and, eventually, the microcapsule walls become fully impermeable to even the free radicals. At this point, polymerization is limited to the exterior surface of the microcapsule wall where the free radicals effect polymerization of any accessible monomer/oligomers/prepolymers and/or prepolymer intermediates and/or any pendant reactive groups so as to enhance or increase the extent of polymerization on the exterior surface of the microcapsules than is attainable in the absence of a continuous phase initiator or catalyst.

The so formed microcapsules are then isolated and/or recovered by conventional techniques. The microcapsules can be used in a myriad of applications depending upon the core material encapsulated therein.

Though, as noted above, the present teaching is applicable to all microcapsule wall forming chemistries, it is especially applicable to those wherein the microcapsule wall is formed through free radical polymerization. All of these chemistries and their formulations are well known to those of average skill in the art and need not be fully disclosed: indeed, if one were to try to describe in detail all of the known and applicable chemistries, this specification would go on and on for pages on end. Suitable microcapsule wall forming materials, compositions and systems are described in, among others, Jahns et. al.—US 2003/0118822A1, U.S. Pat. No. 6,200,681B1; Grey—U.S. Pat. No. 8,784,984B2; Lee et. al.—US 2006/0281834A1 and US2007/0138673; Annable et. al.—US 2011/0169900A1; Schwantes—U.S. Pat. No. 8,715,544B2; U.S. Pat. No. 8,455,098B2, and U.S. Pat. No. 8,071,214; Gould et. al.—U.S. Pat. No. 3,772,215; Nguyen et. al.—U.S. Pat. No. 6,057,384; Popplewell et. al.—US 2004/0071746A1; Ness et. al. US 2006/0039934 A1; Cunningham et. al.—U.S. Pat. No. 6,869,923; Mistry et. al.—US 2013/0302392A1; Asano et. al.—U.S. Pat. No. 4,760,108; Hart et. al.—U.S. Pat. No. 7,550,200 and U.S. Pat. No. 7,938,897; Liang et. al.—U.S. Pat. No. 4,977,060; Sakamoto et. al.—U.S. Pat. No. 5,061,410; Bodmer et. al.—U.S. Pat. No. 6,544,926; Jobmann et. al.—U.S. Pat. No. 7,947,370 and US 2008/0227888A1; Bowman—U.S. Pat. No. 4,675,249; Gartner—U.S. Pat. No. 5,110,883; Soper—U.S. Pat. No. 5,071,706B1; etc., all of which are hereby incorporated herein in their entirety. Though a number of there citations describe multilayered microcapsules, the wall forming chemistries of the individual layers are applicable here.

Notwithstanding the fact that the chemistries are standard in the art, for completeness, especially for those who are new to the art, Applicant will describe the preferred microcpasules, i.e., those whose walls are formed of free radically polymerizable acrylic ester monomers, oligomers and prepolymers.

Oil-in-Water

An oil-in-water microencapsulation process employs a dispersed oil phase composition in water or an aqueous based solution or medium. The oil phase composition comprises, as noted above, the oil phase monomer, the core material, typically a hydrophobic core material, and an oil phase initiator.

Hydrophobic Core Material

The hydrophobic core material may be any of a number of different materials depending upon the intended utility of the microcapsules. Typical core materials include UV absorbers, UV reflectors, pigments, dyes, colorants, scale inhibitors, corrosion inhibitors, antioxidants, pour point depressants, waxes, deposition inhibitors, dispersants, flame retardants, biocides, active dye tracer materials, odor control agents, natural oils, flavor and perfumes oils, crop protection agents, phase change materials and the like. Specific examples of suitable hydrophobic core materials include:
aliphatic hydrocarbon compounds such as saturated or unsaturated C₁₀-C₄₀ hydrocarbons which are branched or preferably linear, e.g. n-tetradecane, n-pentadecane, n-hexadecane, n-heptadecane, n-octadecane, n-nonadecane, n-eicosane, n-heneicosane, n-docosane, n-tricosane, n-tetracosane, n-pentaco-sane, n-hexacosane, n-heptacosane, n-octacosane, and also cyclic hydrocarbons, e.g. cyclohexane, cyclooctane, cyclodecane;
aromatic hydrocarbon compounds such as benzene, napthalene, biphenyl, o- or n-terphenyl, C₁-C₄ alkyl-substituted aromatic hydrocarbons such as dodecylbenzene, tetradecylbenzene, hexadecylbenzene, hexylnaphthalene or decylnaphthalene;
saturated or unsaturated C₆-C₃₀ fatty acids such as lauric acid, stearic acid, oleic acid or behenic acid, preferably eutectic mixtures of decanoic acid with, for example, myristic, palmitic or lauric acid;
fatty alcohols such as lauryl, stearyl, oleyl, myristyl, cetyl alcohol, mixtures such as coconut fatty alcohol and also oxo alcohols which are obtained by hydroformylation of alpha-olefins and further reactions;
C₆-C₃₀ fatty amines such as decylamine, dodecylamine, tetradecylamine or hexadecylamine;
esters such as C₁-C₁₀ alkyl esters of fatty acids, e.g. propyl palmitate, methyl stearate or methyl palmitate, and preferably their eutectic mixtures, or methyl cinnamate;
natural and synthetic waxes such as montan waxes, montan ester waxes, caranuba wax, polyethylene wax, oxidized waxes, polyvinyl ether wax, ethylene-vinyl acetate wax or hard waxes obtained from the Fischer-Tropsch process;
halogenated hydrocarbons such as chloroparaffins, bromooctadecane, bromopentadecane, bromononadecane, bromoeicosane, and bromodocosane.

Most especially the microcapsule according to the present teachings have a phase change material as the core material. Suitable phase change materials are typically known hydrocarbons that melt at a temperature of between −30° C. and 150° C. Generally the substance is a wax or an oil and preferably has a melting point at between 20° C. and 80° C., often around 40° C. Desirably the phase change substance may be a C₈-C₄₀ alkane or cycloalkane. Suitable phase change materials include all isomers of the alkanes or cycloalkanes. In addition it may also be desirably to use mixtures of these alkanes and/or cycloalkanes. The phase change material may be for instance any of the compounds selected from n-octadecane, n-tetradecane, n-pentadecane, n-heptadecane, n-octadecane, n-nonadecane, n-docosane, n-tricosane, n-pentacosane, n-hexacosane, cyclohexane, cyclooctane, cyclodecane and also isomers and/or mixtures thereof. Other phase change materials include aromatic hydrocarbons such as benzene, naphthalene, etc.; fatty acids such as lauric acid, stearic acid, etc.; alcohols such as lauryl alcohol, stearyl alcohol; and ester compounds such alkyl myristate, alkyl palmitate, alkyl stearate, etc., including, specifically, methyl stearate, methyl cinnamate, etc.

Another preferred core material consists essentially of a hydrophobic liquid, preferably an oil, or a hydrophobic wax which is a non-polymeric material, and most preferably a phase change material. Although the preferred hydrophobic oils and waxes are essentially non-polymeric, it is contemplated that these materials may contain smaller amounts, generally less than 10%, preferably less than 5% (e.g., 0.5 to 2%), by total weight of core of polymeric additives. Particularly desirable polymeric additives are those that modify the properties of the phase change material. For example, it is known that the temperature at which a phase change material melts on absorbing heat can be significantly different from the temperature at which it solidifies when losing heat. Alternatively, or in addition thereto, especially where the hydrophobic liquid or wax is a phase change material used for thermal storage, the core phase composition may further comprise select nucleating agents, which may also be a polymeric additive, that are found to prevent supercooling of hydrophobic liquids or waxes into which they are incorporated. Especially desirable polymeric additives and nucleating agents are those substances or compounds that will bring the melting and solidifying temperatures of the phase change material closer together. The use of such polymeric additives and/or nucleating agents is particularly desirable for encapsulated phase change materials to be used in various domestic applications or for garments.

Suitable nucleating agents are well known and include metal powders and claim powders. Especially preferred nucleating are those disclosed in Isiguro (U.S. Pat. No. 5,456,852) which is incorporated herein by reference. Generally speaking these nucleating agents have a melting point that is typically 20° C. to 110° C., preferably 30° C. to 100° C., higher than that of the phase change material into which it is incorporated. Suitable exemplary nucleating agents include aliphatic hydrocarbon compounds, aromatic compounds, esters (including fats and oils), fatty acids, alcohols and amides, including, specifically, but not limited thereto, cetyl alcohol, stearyl alcohol, eicosanol, myristic acid, palmitic acid, behenic acid, stearic acid amide, ethylenebisoleic acid amide, methylolbehenic acid amide and N-phenyl-N′-stearylurea, as well as combinations of two or more thereof. When the phase change compound is a nonpolar compound such as an aliphatic hydrocarbon or an aromatic hydrocarbon, preferable examples of the nucleating agent are fatty acids, alcohols and amides which have a higher polarity than does the nonpolar compound. Generally speaking the nucleating agent is used in an amount of from 0.5 to 40 weight %, preferably 1 to 35 weight %, relative to the amount or weight of the phase change material.

Alternatively, the phase change material may be a substance other than a hydrocarbon. For example, the phase change material could be an inorganic substance that absorbs and desorbs latent heat during a liquefying and solidifying phase transition and/or during dissolving/crystallization transition. Such inorganic compounds include for instance sodium sulphate decahydrate or calcium chloride hexahydrate as well as other inorganic compounds containing a large amount of water of crystallization, for example, sodium hydrogenphosphate dodecahydrate, sodium thiosulfate pentahydrate, and nickel nitrate hexahydrate. Thus the inorganic phase change material may be any inorganic substance that can absorb or desorb thermal energy during a transition at a particular temperature.

In following, the inorganic phase change material may be in the form of finely dispersed crystals which are dispersed throughout the core matrix which comprises a hydrophobic liquid or wax. In one form, the inorganic phase change material is dispersed throughout a solid hydrophobic substance such as a wax. In another form, crystals of the inorganic phase change material may be dispersed in a hydrophobic liquid or wax which remains substantially liquid, preferably a hydrocarbon liquid or wax. During a phase change these crystals become liquid droplets dispersed throughout the liquid. In order to prevent coalescence of these dispersed liquid droplets, it is advantageous to include a suitable surfactant, such as a water-in-oil emulsifier into the hydrophobic liquid. In yet another iteration of this embodiment where the core material comprises an inorganic phase change material dispersed throughout a matrix of a hydrophobic liquid or wax, the hydrophobic liquid or wax is itself a phase change material. In this preferred embodiment the hydrocarbon and inorganic materials may both absorb or desorb heat. Still, the hydrocarbon may not be a phase change material and may just serve as a carrier and/or process aid.

Although the discussion above with respect to the use of nucleating agents with phase change materials is presented with respect to certain hydrocarbon oils and waxes, it is to be appreciated that such nucleating agents, at the stated levels, are also suitably used with any phase change materials, including the aforementioned inorganic materials, to address supercooling and the like.

Oil Phase Monomer

The second component of the oil phase composition is the oil phase monomer. The oil phase monomer comprises one or more ethylenically unsaturated monomers, preferably free-radically polymerizable ethylenically unsaturated monomers, that comprise or are wholly or partially soluble or dispersible in the oil phase composition, especially the hydrophobic core material, and whose oligomers/prepolymers become less soluble and/or less lipophilic and/or less hydrophobic (preferably more hydrophilic) as they oligomerize/prepolymerize whereby the oligomers and/or prepolymers tend to migrate through the oil phase composition to the interface of the oil phase composition and the water or continuous phase. Preferably, the core monomers are hydrophobic monomers, by which is meant a monomer with a water solubility of not more than about 25 g/L, preferably not more than 10 g/L, more preferably not more than 5 g/L as measured in deionized water at 20° C. In certain embodiments the hydrophobic monomers will have water solubility of no more than 1 g/L water, preferably not more than 0.1 g/L as measured in deionized water at 20° C.

The preferred core monomers are those difunctional monomers having the requisite characteristics defined above alone or in combination with other core monomers provided that at least 50 mole % of the core monomers are difunctional. Monomers which do not meet the requirements of the core monomers may also be present and may copolymerize with the requisite core monomer so long as the overall properties of the oligomers/prepolymers is retained. Generally speaking, such other monomers, if present, will be present at less than 50 mole %, preferably less than 25 mole % of the monomer in the core phase. Suitable difunctional core monomers include, but are not limited to, ethylene glycol di(meth)acrylate; 1,3-butylene glycol di(meth)acrylate; 1,4-butylene glycol di(meth)acrylate; propylene glycol di(meth)acrylate; divinyl adipate; divinyl benzene; vinyl methacrylate; allyl (meth)acrylate; diallyl maleate; diallyl phthalate; diallyl fumarate; triallyl cyanurate; (meth)acryl polyesters of polyhydroxylated compounds; divinyl esters of polycarboxylic acids; diallyl esters of polycarboxylic acids; diallyl terephthalate; N,N′-methylene diacrylamide; hexamethylene bis maleimide; diallyl succinate; divinyl ether, the divinyl ethers of ethylene glycol or diethylene glycol; n-methylol acrylamide; n-isobutoxymethyl acrylamide; hexanediol diacrylate; neopentyl glycol diacrylate; divinyl benzene; triethylene glycol di(meth)acrylate; the butylene glycol di(meth)acrylates; tetraethylene glycol di(meth)acrylate; polyethylene glycol di(meth)acrylate; ethylene glycol di(meth)acrylate; diethylene glycol di(meth)acrylate; 1,6 hexanediol di(meth)acrylate; neopentyl glycol diacrylate; tripropylene glycol diacrylate; ethoxylated bisphenol A di(meth)acrylate; dipropylene glycol diacrylate; alkoxylated hexanediol diacrylate; alkoxylated cyclohexane dimethanol diacrylate; propoxylated neopentyl glycol diacrylate; allyl methacrylate; bis-phenol A di(meth)acrylate; and the like.

While the difunctional core monomers are preferred, mono- and poly-functional monomers are suitable as well, as well as combinations thereof and combinations of such monomers with difunctional monomers. Exemplary mono-functional monomers include, but are not limited to, vinyl 2-ethylhexanoate, vinyl laurate, vinyl stearate, vinyl alkyl or aryl ethers with (C₉-C₃₀) alkyl groups such as stearyl vinyl ether; (C₆-C₃₀) alkyl esters of (meth-)acrylic acid, such as hexyl (meth)acrylate, heptyl (meth)acrylate, octyl (meth)acrylate, isooctyl acrylate, isononyl acrylate, decyl (meth)acrylate, isodecyl (meth)acrylate, dodecyl (meth)acrylate, 2-ethylhexyl (meth)acrylate, benzyl (meth)acrylate, lauryl (meth)acrylate, oleyl (meth)acrylate, palmityl (meth)acrylate, and stearyl (meth)acrylate; unsaturated vinyl esters of (meth)acrylic acid such as those derived from fatty acids and fatty alcohols; monomers derived from cholesterol; olefinic monomers such as 1-butene, 2-butene, 1-pentene, 1-hexene, 1-octene, isobutylene and isoprene; and the like. Exemplary polyfunctional monomers include, but are not limited to aliphatic or aromatic urethane acrylates, such as hexa-functional aromatic urethane (meth)acrylates; ethoxylated aliphatic difunctional urethane (meth)acrylates; aliphatic or aromatic urethane (meth)acrylates, such as tetra-functional aromatic (meth)acrylates; epoxy acrylates; epoxymethacrylates; glyceryl tri(meth)acrylate, trimethylolpropane tri(meth)acrylate; pentaerythritol tetra(meth)-acrylate; ethoxylated trimethylolpropane tri(meth)acrylate; propoxylated trimethylolpropane tri(meth)acrylate; propoxylated glyceryl tri(meth)acrylate; ditrimethylolpropane tetra(meth)acrylate; dipentaerythritol pentaacrylate; ethoxylated pentaerythritol tetraacrylate; and the like.

The amount of oil phase monomer present in the oil phase composition may vary, but is generally within the range of from about 5-25 wt %, preferably from about 10-20 wt %, based on the total weight of the oil phase composition. Lower concentrations may be used but too low an amount of the core monomer results in a lessening in the physical properties attained. Higher amounts could also be used but are not needed and, in any event, the more wall material, the less the core material. Hence, it is desirable, as will be noted below, to optimize the amount of the core material while minimizing the amount of shell wall material.

Oil Phase Initiator

The oil phase initiator may be a single initiator or, especially if one desires to form a prepolymer intermediate in-situ, a combination of two free radical initiators each of which is initiated or activated by different conditions or, if by the same conditions, by different intensities of that condition. For example, if the core initiators are both activated by heat, then each will have a primary activation temperature that is different from the other, preferably, the activation temperatures will differ by at least 5° C., more preferably by at least 10° C., most preferably by at least 15° C. Here the concept of primary activation temperature or primary activation condition refers to that condition under which a given initiator achieves a 10 hour half-life. Selection of the initiator will depend upon the mode of activation and the monomer to be polymerized. In this regard, although it may be possible to use an actinic radiation activated initiator, at least in the oligomerization/prepolymerization stage, it is most desirable that the core initiator is a heat activated initiator. Similarly, the quantity of the activator to be incorporated into the oil phase composition will depend, in part, upon the amount of core monomer present and/or the decomposition rate at the anticipated reaction conditions. All of these factors are well known and generally set forth in the suppliers' guidelines and product specifications and, in any event can be determined by simple, direct experimentation.

Water-in-Oil

A water-in-oil microencapsulation process employs a dispersed water phase composition in an oil or organic solution or medium. The water phase composition comprises, as noted above, the water phase monomer, a hydrophilic core material, and a water phase initiator.

Hydrophilic Core Material

The hydrophilic core material is an hydrophilic solid material or an aqueous or aqueous based liquid, or in any event a polar liquid, most typically a solid material dissolved in or dispersed or suspended in water or an aqueous solution. Exemplary hydrophilic solids include dyes, agrichemicals, fertilizers, pharmaceuticals, and the like.

Water Phase Monomer

Water phase monomer comprises one or more polymerizable ethylenically unsaturated monomers, preferably free-radically polymerizable ethylenically unsaturated monomers that manifest, at worst, poor to moderate hydrophilic properties. Most preferably, they are readily hydrophilic/water soluble. The water phase monomer generally comprises 1-100 wt %, preferably 30-100 wt %, of at least one difunctional ethylenically unsaturated monomer; 0-99 wt %, preferably, 0-70 wt %, of at least one polyfunctional ethylenically unsaturated monomer, and 0-60 wt %, preferably 0-30 wt %, of other mono-functional monomers. Generally speaking, if present, suitable poor to moderately hydrophilic water phase monomers are characterized as having one or more acrylate or methacrylate groups or other hydrophilic groups such as amino, urethane, alcohol and/or ether groups and a hydrophobic or non-hydrophilic hydrocarbon or hetero-hydrocarbon portion wherein the hydrocarbon portion is generally large enough such that, as the monomer polymerizes, the so formed oligomer/prepolymer becomes less soluble in the water phase and/or tends to manifest less hydrophilicity and/or tend to increase in hydrophobicity or lipophilicity than the monomer whereby their oligomers and prepolymers tend to migrate to the interface of the oil phase and the water phase, typically as a result of a lessening of attractiveness or increased repellency to the water phase and/or an increased attractiveness or drawing of the oligomer/prepolymer to the oil phase. The hydrocarbon or heterohydrocarbon portion of the water phase monomers may be a saturated or unsaturated hydrocarbon moiety such as an alkyl, alkenyl, alkylene or alkenylene group or a heteroalkyl, heteroalkenyl, heteroalkylene or heteroalkenylene group: hydrocarbon referring to moieties consisting essentially of carbon and hydrogen atoms and hetero referring to the presence of atoms other than, though in addition to, hydrogen and carbon (hetero atoms), most typically oxygen, nitrogen, sulfur and/or a halogen. Where such hetero atoms are present, they typically comprise less than 60 wt %, preferably, less than 40 wt %, more preferably less than 20 wt %, most preferably less than 10 wt % of the given hydrocarbon moiety of which they form a part and may be present in the main chain or as substituents thereto, e.g., an ether group or an hydroxy group, respectively. It is also to be appreciated that any of these hydrocarbon and/or heterohydrocarbon moieties may comprise or include cyclic structures and/or branched structures provided that the monomer manifest the requisite poor to moderately hydrophilic character as described herein, and provided that the resulting oligomer/prepolymer of the monomer is not insufficiently hydrophobic as described herein above. Preferred hydrocarbon and heterohydrocarbon portions of the monomer generally have from 1 to 8 carbon atoms and most preferably have from 1 to 3 carbon atoms, especially desired are those monomers having one or more methyl, ethyl, and propyl groups.

Preferably, the hydrophobic portion of the monomer can be a saturated hydrocarbon moiety such as:

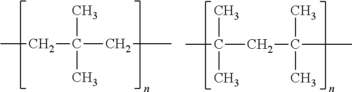

or even an unsaturated hydrocarbon moiety such as

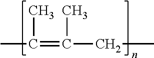

where n is an integer of 1 or greater, preferably 1 to 20. Of course the foregoing structures could also be modified with various hetero atoms, as will be appreciated by those skilled in the art. Furthermore, it is to be appreciated that combinations of the forgoing monomers, combinations of analogous heterohydrocarbon monomers as well as combinations of hydrocarbon and heterohydrocarbon monomers can also be advantageously used.

Those skilled in the art will readily recognize and appreciate that many of the acrylate monomers and oligomers disclosed above for use in the oil phase will have some water solubility or water dispersability, particularly in the presence of a suitable emulsifier, and may be used in the water phase composition. Similarly, they will recognize and appreciate other acrylic esters that possess water solubility, even low water solubility, and/or water dispersability may be used. Generally speaking such water soluble or water dispersible (meth)acrylates contain at least one acrylate or methacrylate group and comprise a hydrocarbon portion that is small such that the ester functional group is enough to impart sufficient hydrophilicity to the monomer, as is the case with, for example, 1,3-butanediol diacrylate. Otherwise, the hydrophobicity of the larger hydrocarbon portion of larger acrylate esters may be overcome by the presence of additional functional groups such as amines, urethanes, alcohols or ethers or combinations thereof which enhance the hydrophilicity. Exemplary water soluble or dispersible acrylates or methacrylates include amine modified polyether (meth)acrylate oligomers, hexafunctional aromatic urethane (meth)acrylate oligomers, hydroxyethyl (meth)acrylate, hydroxypropyl (meth)acrylate, methyl methacrylate, butanediol di(meth)acrylate, hexanediol di(meth)acrylate, ethoxylated bisphenol-A diacrylate, ethoxylated bisphenol-A dimethacrylate, isobornyl (meth)acrylate, pentaerythritol tri(meth)acrylate, pentaerythritol tetra(meth)acrylate, penta(meth)acrylate ester, diethylene glycol di(meth)acrylate, dipropylene glycol di(meth)acrylate, triethylene glycol di(meth)acrylate, tripropylene glycol di(meth)acrylate, neopentyl glycol di(meth)acrylate, trimethylolpropane tri(meth)acrylate, methoxy polyethylene glycol mono(meth)acrylate, ethoxylated trimethylolpropane tri(meth)acrylate, and ethoxylated pentaerythritol tetra(meth)acrylate, difunctional aliphatic epoxy (meth)acrylates, polyethylene glycol di(meth)acrylate, polypropylene glycol di(meth)acrylate, alkoxylated mono- or multi-functional (meth)acrylate ester, polyester (meth)acrylate oligomers, amine modified polyether (meth)acrylate oligomers and the like. Especially preferred water soluble or water dispersible (meth)acrylates are the polyethylene glycol di(meth)acrylates, ethoxylated mono- or multi-functional (meth)acrylates, and (meth)acrylate monomers and/or oligomers that are capable of being dispersed in water with a small amount of a suitable emulsifier.

The amount of water phase monomer present in the water phase composition may vary, but is generally within the range of from about 5-25 wt %, preferably from about 10-20 wt %, based on the total weight of the water phase composition. Lower concentrations may be used but too low an amount of the core monomer results in a lessening in the physical properties attained. Higher amounts could also be used but are not needed and, in any event, the more wall material, the less the core material. Hence, it is desirable, as will be noted below, to optimize the amount of the core material while minimizing the amount of shell wall material.

Water Phase Initiator

The water phase composition comprises the one or more water phase initiators that are suitable for effecting oligomerization/prepolymerization and/or polymerization of the water phase monomer. Though a single water phase initiator will suffice, two or more may be used and at least two are use if one desires to form a prepolymer intermediate in-situ from the water phase monomer. As with the oil phase initiator, the water phase initiator may comprise two free radical initiators each of which is initiated or activated by different conditions or, if by the same conditions, by different intensities of that condition. Again, for example, if the core initiators are both activate by heat, then each will have a primary activation temperature that is different from the other, preferably, the activation temperatures will differ by at least 5° C., more preferably at least 10° C., most preferably by at least 15° C.; wherein the primary activation temperature or primary activation condition refers to that condition under which a given initiator achieves a 10 hour half-life. Selection of the water phase initiator will depend upon the mode of activation and the monomer to be polymerized. In this regard, while the water phase initiator may be actinic radiation, (e.g., UV light), activated, like the core initiators, the water phase initiators are preferably heat activated. Similarly, the quantity of the water phase activator to be incorporated into the water phase composition will depend, in part, upon the amount of water phase monomer present and/or the decomposition rate of the water phase activator under the given reaction conditions. All of these factors are well known and generally set forth in the suppliers' guidelines and product specifications and, in any event can be determined by simple, direct experimentation.

Dual Initiators

As noted above, one of the key aspects of the present teaching is that both the continuous phase and the dispersed phase have or be modified in the course of microencapsulation to have a free radical initiator. The initiators to be added to the continuous phase are the same as discussed above as if they were to be employed in the dispersed phase. The amounts, likewise are similar, though; owing to the dilution factor in the continuous phase, a larger amount may be employed to ensure sufficient and timely polymerization and shell wall formation. Also, as noted above, the initiator for the continuous phase must be added after the formation of the seed capsule if it is initiated by conditions that effect formation of the seed capsule, i.e., by conditions that affect the initiator of the dispersed phase. For example, if the dispersed phase has a heat activated initiator and the continuous phase employs a photoactive initiator, or vice-versa, the initiators may be added to both the water phase composition and the oil phase composition at the time of their preparation. On the other hand, if the conditions that effect the initiator for seed capsule formation also effect initiation of the continuous phase initiator then the latter is not added to the continuous phase until after formation of the seed microcapsule.

Preferably, it is desirable to select water phase initiators and oil phase initiators that have the same or similar activation condition as that will simplify the final polymerization step and microcapsule formation. Alternatively, if the dispersed phase has a plurality of initiators one for effecting formation of the seed capsule and another for effecting full microcapsule formation, it is preferable that the second dispersed phase initiator and the continuous phase initiator have the same or similar activation conditions.

Oil Phase Continuous Phase

In the case of the water-in-oil microencapsulation process, the oil continuous phase is preferably a high boiling, e.g., greater than at least 100° C., hydrocarbon and/or ester, preferably esters with chain length up to about 18 carbons or even up to about 42 carbons or triglycerides such as esters of C₆ to C₁₂ fatty acids and glycerol. The oil continuous phase or oil phase used interchangeably for purposes hereof can be selected from hydrocarbons, more particularly hydrocarbon solvents and the solvents can include by way of illustration and not limitation, ethyldiphenylmethane, butyl biphenyl ethane, benzylxylene, alkyl biphenyls such as propylbiphenyl and butylbiphenyl, dialkyl phthalates e.g. dibutyl phthalate, dioctylphthalate, dinonyl phthalate and ditridecylphthalate; 2,2,4-trimethyl-1,3-pentanediol diisobutyrate, alkyl benzenes such as dodecyl benzene; but also carboxylates, ethers, or ketones such as diaryl ethers, di(aralkyl)ethers and aryl aralkyl ethers, ethers such as diphenyl ether, dibenzyl ether and phenyl benzyl ether, liquid higher alkyl ketones (having at least 9 carbon atoms), alkyl or aralky benzoates, e.g., benzyl benzoate, alkylated naphthalenes such as dipropylnaphthalene, partially hydrogenated terphenyls; high-boiling straight or branched chain hydrocarbons, arenes and alkaryl hydrocarbons such as toluene, vegetable oils such as canola oil, soybean oil, coin oil, sunflower oil, or cottonseed oil, methyl esters of fatty acids derived from transesterification of canola oil, soybean oil, cottonseed oil, corn oil, sunflower oil, pine oil, lemon oil, olive oil, or methyl ester of oleic acid, vegetable oils, esters of vegetable oils, e.g. soybean methyl ester, straight chain saturated paraffinic aliphatic hydrocarbons of from 10 to 13 carbons; C₈ to C₄₂ esters ethyl hexanoate, methyl heptanoate, butyl butyrate, methyl benzoate, methyl such as nonoate, methyl decanoate, methyl dodecanoate, methyl octanoate, methyl laurate, methyl myristate, methyl palmitate, methyl stearate, ethyl heptanoate, ethyl octanoate, ethyl nonoate, ethyl decanoate, ethyl dodecanoate, ethyl laurate, ethyl myristate, ethyl palmitate, ethyl stearate, isopropyl myristate, isopropyl palmitate, ethylhexyl palmitate, isoamyl laurate, butyl laurate, octyl octanoate, decyl decanoate, butyl stearate, lauryl laurate, stearyl palmitate, stearyl stearate, stearyl behanate, and behenyl behenate. Mixtures of the above can also be employed. Common diluents such as straight chain hydrocarbons can also be blended with the solvents, or blend of solvents.

Water Phase Continuous Phase

In the case of an oil-in-water microencapsulation process, the continuous phase is water or an aqueous based solution. Other polar solvents are possible: though not encouraged due to environmental/waste concerns, cost and the like.

Processing Aids

Emulsifier/Dispersants

Optionally, though preferably, the continuous phase composition will also contain an emulsifier to aid in the creation of the dispersion or emulsification of the dispersed phase therein, i.e., of the oil phase composition in the continuous water phase and of the water phase composition in the continuous oil phase. Selection of the emulsifier is largely dependent upon which is the dispersed phase and which is the continuous phase. Emulsifiers and dispersants may also be used to aid in the getting the wall forming polymerizable monomer into their respective solutions. For example, it may be desirable to employ a non-ionic emulsifier in preparing the water phase composition where one or more of the water phase monomers has only poor to moderate solubility in the water phase composition.

Emulsifiers of all types are suitable for use in the practice of the present process though it is to be appreciated, and those skilled in the art will readily recognize that different systems, e.g., different core monomer and/or core materials, will be better suited with one or more classes of emulsifiers than others. Specifically, while the present teachings are applicable to anionic, cationic, non-ionic and amphoteric emulsifiers generally, preferred emulsifiers for use with the oil in water encapsulation processes are the cationic and non-ionic emulsifiers, particularly those having polyalkylether units, especially polyethylene oxide units, with degrees of polymerization of the alkylene ether unit of greater than about 6. Preferred emulsifiers are those which significantly reduce the interfacial tension between the continuous water phase and dispersed oil phase composition, and thereby reduce the tendency for droplet coalescence. In this regard, generally the emulsifiers for use in the water phase for aiding in the oil in water emulsion or dispersion will have HLB values of from 11 to 17. Alternatively, or in addition thereto, emulsifiers of the same HLB value may also be used in the water phase to enhance the solubility and/or dispersability of the water phase monomer; though preferably such emulsifiers will generally have HLB values of 16 to 20. Of course, emulsifiers/surfactants of lower and higher HLB values that achieve the same objective as noted are also included.

Exemplary emulsifiers include, but are not limited to polyvinyl alcohols, especially those that are partially hydrolyzed; cellulose derivatives such as ethyl hydroxyethyl cellulose, 2-hydroxyethyl cellulose, hydroxybutyl methycellulose, hydroxypropyl methylcellulose, etc.; gums such as acacia gum and xantham gum; poly(meth)acrylic acids and derivatives; and poly(styrene-co-maleic acid) and derivatives and the like. Most preferably, the emulsifier/emulsion stabilizer is a polyvinyl alcohol, particularly a polyvinyl alcohol that has been derived from polyvinyl acetate, wherein between 85 and 95%, preferably 88 to 90% of the vinyl acetate groups have been hydrolyzed to vinyl alcohol units.

Additional exemplary anionic surfactants and classes of anionic surfactants suitable for use in the practice of the present invention include: sulfonates; sulfates; sulfosuccinates; sarcosinates; alcohol sulfates; alcohol ether sulfates; alkylaryl ether sulfates; alkylaryl sulfonates such as alkylbenzene sulfonates and alkylnaphthalene sulfonates and salts thereof; alkyl sulfonates; mono- or di-phosphate esters of polyalkoxylated alkyl alcohols or alkylphenols; mono- or di-sulfosuccinate esters of C₁₂ to C₁₅ alkanols or polyalkoxylated C₁₂ to C₁₅ alkanols; ether carboxylates, especially alcohol ether carboxylates; phenolic ether carboxylates; polybasic acid esters of ethoxylated polyoxyalkylene glycols consisting of oxybutylene or the residue of tetrahydrofuran; sulfoalkylamides and salts thereof such as N-methyl-N-oleoyltaurate Na salt; polyoxyalkylene alkylphenol carboxylates; polyoxyalkylene alcohol carboxylates alkyl polyglycoside/alkenyl succinic anhydride condensation products; alkyl ester sulfates; naphthalene sulfonates; naphthalene formaldehyde condensates; alkyl sulfonamides; sulfonated aliphatic polyesters; sulfate esters of styrylphenyl alkoxylates; and sulfonate esters of styrylphenyl alkoxylates and their corresponding sodium, potassium, calcium, magnesium, zinc, ammonium, alkylammonium, diethanolammonium, or triethanolammonium salts; salts of ligninsulfonic acid such as the sodium, potassium, magnesium, calcium or ammonium salt; polyarylphenol polyalkoxyether sulfates and polyarylphenol polyalkoxyether phosphates; and sulfated alkyl phenol ethoxylates and phosphated alkyl phenol ethoxylates; sodium lauryl sulfate; sodium laureth sulfate; ammonium lauryl sulfate; ammonium laureth sulfate; sodium methyl cocoyl taurate; sodium lauroyl sarcosinate; sodium cocoyl sarcosinate; potassium coco hydrolyzed collagen; TEA (triethanolamine) lauryl sulfate; TEA (Triethanolamine) laureth sulfate; lauryl or cocoyl sarcosine; disodium oleamide sulfosuccinate; disodium laureth sulfosuccinate; disodium dioctyl sulfosuccinate; N-methyl-N-oleoyltaurate Na salt; tristyrylphenol sulphate; ethoxylated lignin sulfonate; ethoxylated nonylphenol phosphate ester, calcium alkylbenzene sulfonate; ethoxylated tridecylalcohol phosphate ester; dialkyl sulfosuccinates; perfluoro (C₆-C₁₈)alkyl phosphonic acids; perfluoro(C₆-C₁₈)alkyl-phosphinic acids; perfluoro(C₃-C₂₀)alkyl esters of carboxylic acids; alkenyl succinic acid diglucamides; alkenyl succinic acid alkoxylates; sodium dialkyl sulfosuccinates; and alkenyl succinic acid alkylpolyglykosides. Further exemplification of suitable anionic emulsifiers include, but are not limited to, water-soluble salts of alkyl sulfates, alkyl ether sulfates, alkyl isothionates, alkyl carboxylates, alkyl sulfosuccinates, alkyl succinamates, alkyl sulfate salts such as sodium dodecyl sulfate, alkyl sarcosinates, alkyl derivatives of protein hydrolyzates, acyl aspartates, alkyl or alkyl ether or alkylaryl ether phosphate esters, sodium dodecyl sulphate, phospholipids or lecithin, or soaps, sodium, potassium or ammonium stearate, oleate or palmitate, alkylarylsulfonic acid salts such as sodium dodecylbenzenesulfonate, sodium dialkylsulfosuccinates, dioctyl sulfosuccinate, sodium dilaurylsulfosuccinate, poly(styrene sulfonate) sodium salt, alkylene-maleic anhydride copolymers such as isobutylene-maleic anhydride copolymer, or ethylene maleic anhydride copolymer gum arabic, sodium alginate, carboxymethylcellulose, cellulose sulfate and pectin, poly(styrene sulfonate), pectic acid, tragacanth gum, almond gum and agar; semi-synthetic polymers such as carboxymethyl cellulose, sulfated cellulose, sulfated methylcellulose, carboxymethyl starch, phosphated starch, lignin sulfonic acid; maleic anhydride copolymers (including hydrolyzates thereof), polyacrylic acid, polymethacrylic acid, acrylic acid alkyl acrylate copolymers such as acrylic acid butyl acrylate copolymer or crotonic acid homopolymers and copolymers, vinylbenzenesulfonic acid or 2-acrylamido-2-methylpropanesulfonic acid homopolymers and copolymers, and partial amide or partial ester of such polymers and copolymers, carboxymodified polyvinyl alcohol, sulfonic acid-modified polyvinyl alcohol and phosphoric acid-modified polyvinyl alcohol, phosphated or sulfated tristyrylphenol ethoxylates.

Exemplary amphoteric and cationic emulsifiers include alkylpolyglycosides; betaines; sulfobetaines; glycinates; alkanol amides of C₈ to C₁₈ fatty acids and C₈ to C₁₈ fatty amine polyalkoxylates; C₁₀ to C₁₈ alkyldimethylbenzylammonium chlorides; coconut alkyldimethylaminoacetic acids; phosphate esters of C₈ to C₁₈ fatty amine polyalkoxylates; alkylpolyglycosides (APG) obtainable from an acid-catalyzed Fischer reaction of starch or glucose syrups with fatty alcohols, in particular C₈ to C₁₈ alcohols, especially the C₈ to C₁₀ and C₁₂ to C₁₄ alkylpolyglycosides having a degree of polymerization of 1.3 to 1.6., in particular 1.4 or 1.5. Additional cationic emulsifiers include quaternary ammonium compounds with a long-chain aliphatic radical, e.g. distearyldiammonium chloride, and fafty amines. Among the cationic emulsifiers which may be mentioned are alkyldimethylbenzylammonium halides, alkyldimethylethyl ammonium halides, etc. specific cationic emulsifiers include palmitamidopropyl trimonium chloride, distearyl dimonium chloride, cetyltrimethylammonium chloride, and polyethyleneimine. Additional amphoteric emulsifiers include alkylaminoalkane carboxylic acids betaines, sulphobetaines, imidazoline derivatives, lauroamphoglycinate, sodium cocoaminopropionate, and the zwitterionic emulsifier cocoamidopropyl betaine.

Suitable non-ionic emulsifiers are characterized as having at least one non-ionic hydrophilic functional group. Preferred non-ionic hydrophilic functional groups are alcohols and amides and combinations thereof. Examples of non-ionic emulsifiers include: mono and diglycerides; polyarylphenol polyethoxy ethers; polyalkylphenol polyethoxy ethers; polyglycol ether derivatives of saturated fatty acids; polyglycol ether derivatives of unsaturated fatty acids; polyglycol ether derivatives of aliphatic alcohols; polyglycol ether derivatives of cycloaliphatic alcohols; fatty acid esters of polyoxyethylene sorbitan; alkoxylated vegetable oils; alkoxylated acetylenic diols; polyalkoxylated alkylphenols; fatty acid alkoxylates; sorbitan alkoxylates; sorbitol esters; C₈ to C₂₂ alkyl or alkenyl polyglycosides; polyalkoxy styrylaryl ethers; amine oxides especially alkylamine oxides; block copolymer ethers; polyalkoxylated fatty glyceride; polyalkylene glycol ethers; linear aliphatic or aromatic polyesters; organo silicones; polyaryl phenols; sorbitol ester alkoxylates; and mono- and diesters of ethylene glycol and mixtures thereof; ethoxylated tristyrylphenol; ethoxylated fatty alcohol; ethoxylated lauryl alcohol; ethoxylated castor oil; and ethoxylated nonylphenol; alkoxylated alcohols, amines or acids; amides of fatty acids such as stearamide, lauramide diethanolamide, and lauramide monoethanolamide; long chain fatty alcohols such as cetyl alcohol and stearyl alcohol; glycerol esters such as glyceryl laurate; polyoxyalkylene glycols and alkyl and aryl ethers of polyoxyalkylene glycols such as polyoxyethylene glycol nonylphenyl ether and polypropylene glycol stearyl ether. Polyethylene glycol oligomers and alkyl or aryl ethers or esters of oligomeric polyethylene glycol are preferred. Also preferred as non-ionic emulsifiers are polyvinyl alcohol, polyvinyl acetate, copolymers of polyvinyl alcohol and polyvinylacetate, carboxylated or partially hydrolyzed polyvinyl alcohol, methyl cellulose, various latex materials, stearates, lecithins, and various surfactants. It is known that polyvinyl alcohol is typically prepared by the partial or complete hydrolysis of polyvinyl acetate. Accordingly, by reference to polyvinyl alcohol we intend to include both completely and partially hydrolyzed polyvinyl acetate. With respect to the latter, it is preferred that the polyvinyl acetate be at least 50 mole % hydrolyzed, more preferably, at least 75 mole % hydrolyzed.

Where the emulsifier is a polymeric emulsifier, especially one having or derived from an acrylic ester, e.g., a polyacrylate, the molecular weight is generally at least 10,000, preferably at least 20,000, most preferably 30,000 or more. Additionally, the amount of emulsifier is typically from about 0.1 to about 40% by weight, more preferably from about 0.2 to about 15 percent, most preferably from about 0.5 to about 10 percent by weight based on the total weight of the formulation. It is to be appreciated that certain acrylic polymers and copolymers may perform both as an emulsifier as well as a polymerizable and/or non-polymerizable component in forming the microcapsule wall. With respect to the latter, the polymeric emulsifier, particularly those in the nature of higher molecular weight polymers, are trapped and/or incorporated into the polymer wall as it is formed. This is especially likely where the nature of the water phase changes and the solubilized polymer comes out of solution.

Other stabilizing substances that may be used, alone or in combination with the aforementioned materials, include ionic monomers. Typical cationic monomers include dialkyl amino alkyl acrylate or methacrylate including quaternary ammonium or acid addition salts and dialkyl amino alkyl acrylamide or methacrylamide including quaternary ammonium or acid addition salts. Typical anionic monomers include ethylenically unsaturated carboxylic or sulphonic monomers such as acrylic acid, methacrylic acid, itaconic acid, allyl sulphonic acid, vinyl sulphonic acid especially alkali metal or ammonium salts. Particularly preferred anionic monomers are ethylenically unsaturated sulphonic acids and salts thereof, especially 2-acrylamido-2-methyl propane sulphonic acid, and salts thereof.

Other Ingredients

The water phase compositions and the oil phase compositions may further contain other ingredients conventional in the art including, e.g., chain transfer agents and/or agents which help control the molecular weight/degree of polymerization of the wall forming monomer, thereby aiding in the movement of the oligomer/prepolymer through the respective oil phase and water phase compositions. In this regard, optionally, though preferably, the water phase composition, further includes at least one chain transfer agent and/or agent which aids in movement of the oligomer/prepolymer. Suitable chain transfer agents include, but are not limited to, lower alkyl alcohols having from 1 to 5 carbon atoms, mercaptoethanol, mercaptopropanol, thioglycolic acid, isooctylmercaptoproprionate, tert-nonylmercaptan, pentaerythritol tetrakis(3-mercaptoproprionate), dodecylmercaptan, formic acid, halogenated hydrocarbons, such as bromoethane, bromotrichloromethane, or carbon tetrachloride, and the sulfate, bisulfate, hydrosulfate, phosphate, monohydrogen phosphate, dihydrogen phosphate, toluene sulfonate, and benzoate salts of sodium and potassium, especially sodium hypophosphite and sodium bisulfate. If present, the chain transfer agents are preferably used in amounts ranging from 0.01 to 5%, preferably from 0.5 to 3%, by weight with respect to the monomers and/or oligomers employed.

Having described the present process in general and specific terms, attention is now directed to the following specific examples which demonstrate the marked benefit of the present process and of the microcapsules resulting therefrom.

### EXAMPLES

Microcapsules were prepared in accordance with the present teaching and the same subjected to visual and chemical evaluation to check on morphology and shell wall integrity as ascertained by Free Wax Analysis and TGA Analysis. Table 1 sets forth the various trade-named ingredients that were/may be employed in the examples.

TABLE 1

| | | Solubility in water |
|---|---|---|
| Component | Chemistry | (g/L @ 25° C.) |
| SR206 | Ethylene glycol dimethacrylate | 2.4 |
| CN551 | tetrafunctional amine modified polyether acrylate | |
| | oligomer | |
| SR247 | Neopentyl glycol diacrylate | 0.94 |
| SR602 | Ethoxylated (10) bisphenol A diacrylate | |
| SR601 | Ethoxylated (4) bisphenol A diacrylate | 0.45 |
| SR256 | 2-(2-ethoxyethoxy) ethyl acrylate | 25.33 |
| SR259 | Polyethylene glycol 200 diacrylate | 40.68 |
| SR399 | DIPENTAERYTHRITOL PENTAACRYLATE | |
| SR349 | Ethoxylated (3) bisphenol A diacrylate | |
| SR9035 | 15-mole, ethoxylated, trimethylolpropane triacrylate | Water soluble |
| SR9038 | ethoxylated (30) bisphenol A diacrylate | Water soluble |
| SR344 | Polyethylene glycol 400 diacrylate | Water soluble |
| SR610 | polyethylene glycol (600) diacrylate | Water soluble |
| SR295 | PENTAERYTHRITOL TETRAACRYLATE | 4.23 |
| MMA | Methyl methacrylate | |
| V-50 | 2,2′-azobis(2-amidinopropane) hydrochloride - 10 hour | |
| | ½ life at 56° C. | |
| V-501/ | 4,4′-azobis(4-cyanovaleric acid) | |
| Vazo-501 | | |
| Vazo-67 | 2,2′-azobis(2-methylbutyronitrile) - 10 hour ½ life at | |
| | 67° C. | |
| VA-086 | 2,2′-Azobis[2-methyl-N-(2-hydroxyethyl)propionamide]- | |
| | 10 hour ½ life at 86° C. | |
| Vazo-88 | 1,1′-Azobis(cyclohexanecarbonitrile) - 10 hour ½ life at | |
| | 88° C. | |
| Na₂SO₄ | Sodium sulfate | |
| KPS | Potassium persulfate | |
| BPO | Benzyl peroxide | |
| Polywax ™ | Alkanes | |
| M90 Wax | | |
| PVA523 | Polyvinyl alcohol, partially hydrolyzed | |

Free Wax

Samples of the microcapsule powders were obtained by drying the slurry in a Buchi Mini Spray Dryer B-290. The amount of free wax in the powders was determined by GC analysis using hexane wash. Approximately 0.2 grams of the dried capsules were combined with 10 ml of hexane in a 20 ml scintillation vial and capped tightly and placed on a vortex mixer for 5 seconds before being pipetted into an autosampler vial and analyze by Agilent 7890N GC with Chem Station Software. Column: Phenomenex's ZB-1HT Inferno column @ 10M, 0.32 mm, 0.25 μm, 100%-dimethylpolysiloxane phase or equivalent. Temp: 50° C. for 1 minute then heat to 270° C.@10° C./min. Injector: 270° C. with Split Ration of 10:1. Detector: 320° C., 2 μl injection. The % free wax was calculated by dividing the mg of free wax measured by the sample weight (mg) and multiplying by 100. Free wax is an indicator of the permeability and/or strength of the capsule: a permeable and/or weak wall will show higher levels of free wax.

TGA Analysis

TGA analysis was performed at a temperature ramp up rate of 10° C./min in the TGA Q500 thermal gravimetric analyzer from TA Instruments. The temperature at 10% and 20% weight loss was recorded.

### Example 1

An oil phase composition was prepared by combining 673.2 g octadecane, 6.8 g nucleating agent, 116 g SR206 and 4 g CN551, heating the mixture to 63° C. and mixed until all the components are completely dissolved. Thereafter, 2.8 g Vazo-67 was added to the mixture and further mixed until needed. Similarly, a water phase composition was prepared by combining 24 g of PVA 523 and 1176 g water and heating the combination to 63° C. while mixing. Once both the oil phase composition and the water phase composition were prepared, the oil phase composition is added to the water phase composition while milling. Milling rate is controlled at an appropriate speed to produce an emulsion with the desired size characteristics. In this particular case milling was done at 4800 rpm for 35 minutes.

Once milling was completed, mixing was continued with a 3″ propeller at about 390 rpm and the temperature increased to 82° C. in 30 minutes, held at 82° C. for 2 hours, and subsequently cooled to 70° C. in 70 minutes. Once cooled, a sample was taken from the reaction mix and subjected to photomicrography which confirmed the presence of seed microcapsules. Subsequently, 0.80 g V-50 was added to the reaction mix while continuing to mix and the temperature increased to 75° C. over 4 hours, and further increased to 85° C. in 30 minutes, and then held at 85° C. for 6 hours. The batch was allowed to cool to room temperature at the completion of the heating cycle at which point microcapsule formation had been completed. All batch processing was done under nitrogen blanket.

The microcapsules formed according to Example 1 were found to have a capsule size of 4.5 (um, volume averaged) with a core to wall weight ratio of 85:15. Analysis found a Free Wax of 0.36 (wt %, spray dried powder) and TGA of 171, 191 (powder, ° C. at 10%, 20% loss).

### Example 2

An oil phase composition was prepared by combining 158.3 g octadecane, 1.7 g nucleating agent, 40 g SR206 and 1 g CN551 and heating the mixture to 63° C. while mixing until all the components are completely dissolved. Then, 0.10 g Vazo-67 was added to the oil composition and the mixture allowed to mix until needed. Similarly, a water phase composition was prepared by combining 6.5 g of PVA 523 and 345 g water and heating the combination to 63° C. while mixing. Once both the oil phase composition and the water phase composition were prepared, the oil phase composition is added to the water phase composition while milling. Milling rate is controlled at an appropriate speed to produce an emulsion with the desired size characteristics. In this particular case milling was done at 3800 rpm for 20 minutes and then 3900 rpm for an additional 13 minutes.

Once milling was completed, mixing was continued with a 3″ propeller at about 390 rpm and the temperature increased to 82° C. in 30 minutes and then held at 82° C. for 30 minutes. Thereafter, 1.2 g V-501 was added and the temperature held at 82° C. for an additional 2 hours and then increased to 85° C. in 30 minutes and then held at 85° C. for 4 hours. The batch was allowed to cool to room temperature at the completion of the heating cycle. All batch processing was done under nitrogen blanket.

The microcapsules formed according to Example 2 were found to have a capsule size of 5.0 (um, volume averaged) with a core to wall weight ratio of 85:15. Analysis found a Free Wax of 0.46 (wt %, spray dried powder) and TGA of 197, 210 (powder, ° C. at 10%, 20% loss).

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

Although the process and prepared microcapsules of the present specification as well as various commercial and consumer products containing/comprising the same have been described with respect to specific embodiments and examples, it should be appreciated that the present teachings are not limited thereto and other embodiments utilizing the concepts expressed herein are intended and contemplated without departing from the scope of the present teaching as intended in the true spirit and scope of the invention. It is therefore intended any and all modifications, variations, or equivalents that fall within the spirit and scope of the underlying principles are within the scope of this invention and are covered by the appended claims.

We claim:

1. A process for producing microcapsules which process comprises:
a) forming a dispersion of a core composition in a continuous phase, said core composition comprising a polymerizable wall forming material and at least one initiator or catalyst for effecting the polymerization of said wall forming material,
b) initiating polymerization of the wall forming material in the core composition so as to form a seed microcapsule
c) subjecting the dispersion to conditions that initiate a catalyst or initiator present in the continuous phase which catalyst or initiator is capable of further effecting the polymerization of the wall forming material of the core composition, and
d) allowing polymerization to continue until microcapsules of the desired wall thickness are attained, said process further characterized in that the continuous phase is free of or substantially free of continuous phase monomer.

2. The process of claim 1 wherein the core composition is an oil phase composition and the continuous phase is a water phase.

3. The process of claim 1 wherein the core composition is a water phase composition and the continuous phase is an oil phase.

4. The process of claim 1 wherein core composition comprises one or more free radically polymerizable monomers, oligomers and/or prepolymers as the wall forming material.

5. The process of claim 4 wherein the wall forming material of the core composition is a monomer and/or oligomer composition which is subjected to a pre-polymerization to form a prepolymer intermediate.

6. The process of claim 5 wherein the prepolymer intermediate is formed prior to forming the dispersion.

7. The process of claim 5 wherein the prepolymer intermediate is formed subsequent to forming the dispersion but prior to initiating polymerization of the prepolymer intermediate to form the seed microcapsule.

8. The process of claim 7 wherein the core phase contains two free radical initiators or catalysts, one for effecting formation of the prepolymer intermediate and the other for effecting formation of the seed microcapsule.

9. The process of claim 1 wherein the catalyst or initiator in the continuous phase is added to the continuous phase after formation of the seed microcapsule.

10. The process of claim 9 wherein the catalyst or initiator in the continuous phase is activated by the same conditions as is effective for activating the activator or initiator contained in the core composition.

11. The process of claim 1 wherein the wall forming material of the core composition is a monomer, oligomer and/or prepolymer composition which is not subjected to an in-situ pre-polymerization to form a prepolymer intermediate and the catalyst or initiator in the continuous phase is added during the preparation of the continuous phase and is activated by conditions other than those employed in forming the seed microcapsule.

12. The process of claim 1 wherein the wall forming material of the core composition is a monomer and/or oligomer composition which is subjected to an in-situ pre-polymerization to form a prepolymer intermediate and the catalyst or initiator in the continuous phase is added during the preparation of the continuous phase and is activated by conditions other than those employed in forming the prepolymer intermediate and the seed microcapsule.

13. The process of claim 1 wherein initiation of the initiator or catalyst of the continuous phase does not take place until the seed microcapsule is in the form of a fully ellipsoid.

14. The process of claim 1 wherein the seed microcapsule is of an ellipsoid shape and initiation of the initiator or catalyst of the continuous phase occurs once the seed microcapsule is at least 50% complete.

15. The process of claim 1 wherein the seed microcapsule is of an ellipsoid shape and initiation of the initiator or catalyst of the continuous phase occurs once the seed microcapsule is at least 85% complete.

16. An improved oil-in-water or water-in-oil process for forming microcapsules wherein the microcapsules are formed from wall forming materials in a dispersed phase and the continuous phase is free of or substantially free of continuous phase monomer wherein the improvement comprises forming a seed capsule from the wall forming materials of the dispersed phase and then further polymerizing the wall forming material of the dispersed phase through activation of an initiator or catalyst in the continuous phase, with or without concurrent activation of initiator or catalyst in the dispersed phase.

17. The improved process of claim 16 wherein the initiator or catalyst of the continuous phase is added to the continuous phase after the seed microcapsule has been formed.

18. The improved process of claim 16 wherein the seed microcapsule is a full ellipsoid.

19. The improved process of claim 16 wherein the seed microcapsule is a partial ellipsoid that is at least 50% complete.

20. The improved process of claim 16 wherein the wall forming materials are free radically polymerizable.
